(19) United States
(12) Patent Application Publication
(10) Pub. No.: US 2009/0310106 A1
(43) Pub. Date: Dec. 17, 2009

(54) EXPOSURE APPARATUS AND METHOD OF MANUFACTURING DEVICE

(75) Inventor: Kazuhiko Mishima, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/484,097

(22) Filed: Jun. 12, 2009

(30) Foreign Application Priority Data
Jun. 16, 2008 (JP) 2008-156998

(51) Int. Cl. G03B 27/68

(52) U.S. Cl. 355/52

(57) ABSTRACT

An exposure apparatus which transfers a pattern of a reticle onto a substrate via a projection optical system comprises a controller configured to correct an image of the pattern, formed on the substrate, in accordance with a shape of the reticle in a standby state until an exposure operation starts.

### BACKGROUND OF THE INVENTION

1. Field of the Invention

The present invention relates to an exposure apparatus and a method of manufacturing a device.

2. Description of the Related Art

In recent years, techniques of manufacturing semiconductor devices and micropatterning techniques accompanying them are making remarkable progress. This progress is particularly sustained by a mainstream photofabrication technique that uses a reduction projection exposure apparatus which is commonly called a stepper and has a resolving power on the submicron order. To further improve the resolving power of the exposure apparatus, the numerical aperture (NA) of the optical system is increased and the wavelength of the exposure light is shortened. As the wavelength of the exposure light shortens, the exposure light sources are shifting from high-pressure mercury lamps with the g-line and i-line to a KrF excimer laser and even an ArF excimer laser.

To improve the resolving power and ensure a given depth of focus during exposure, a projection exposure apparatus including a projection optical system which allows exposure while the space between the substrate and the projection exposure optical system is immersed in a liquid has arrived on the market.

The conventional methods of shortening the exposure wavelength and of increasing the NA have practical limits. To overcome this situation, approaches to achieve finer patterns by forming patterns in one process (one of various kinds of processes for forming a semiconductor device) by a plurality of times of exposure have been introduced. These approaches are commonly called the double exposure method or double patterning method.

Also, as the resolving power of the projection pattern improves, there arises a need to increase the accuracy of alignment for relatively aligning a substrate and a mask (reticle) in a projection exposure apparatus. The projection exposure apparatus is required to serve as both a high-resolution exposure apparatus and a high-accuracy position detection apparatus. For this reason, as the micropatterning advances, there arises a need to improve the alignment (overlay) accuracy as well.

The double exposure method that is especially, commonly used as an approach to achieve finer patterns sequentially transfers by exposure the patterns of a plurality of reticles onto a resist, applied on a substrate once, so that these patterns are overlaid on each other. This method does not perform development between successive exposure operations using the plurality of reticles, unlike the conventional counterpart. In this method, the exposure apparatus stores a plurality of reticles in advance, and sequentially exposes one substrate without developing it.

The exposure apparatus is also required to achieve a high throughput, that is, to expose as many substrates as possible per unit time. These days, to achieve all of a high throughput and high alignment and focus accuracies, an exposure apparatus including a plurality of substrate stages (two-stage exposure apparatus) has also arrived on the market. This two-stage exposure apparatus includes a measurement stage (or a measurement area) for measuring, for example, the alignment and focus states, and an exposure stage (or an exposure area) for exposure. The two-stage exposure apparatus generally includes a plurality of stages which reciprocate between these two areas, and exposes a substrate by alternately swapping the plurality of stages between the measurement area and the exposure area. With this arrangement, the two-stage exposure apparatus can perform alignment and exposure not in series but in parallel, unlike the conventional counterpart. In this case, it is possible to improve the throughput and to perform measurement with higher accuracy by securing a long time for alignment measurement.

The reticle generally has a Cr pattern formed on quartz, so it is known to heat up and expand upon absorbing the exposure light during an exposure operation. As the reticle expands, the pattern formed on it also expands, resulting in the generation of pattern overlay errors. Japanese Patent Laid-Open No. 4-192317 discloses an exposure apparatus which performs exposure by measuring the reticle expansion during exposure and correcting the imaging state based on the measurement result in a conventional exposure method of transferring the pattern of one reticle onto a plurality of substrates by exposure.

In the double exposure method, the patterns of a plurality of reticles are alternately transferred onto one substrate by exposure. For example, the process of double exposure using two reticles A and B progresses in the order of alignment measurement, focus measurement, exposure using the reticle A, reticle exchange, exposure using the reticle B, and substrate recovery. A conventional exposure other than the double exposure method does not require reticle exchange between successive exposure operations because this method transfers the pattern of one reticle onto a plurality of substrates by exposure. For this reason, the conventional exposure method need only perform exposure by measuring the reticle expansion and correcting the imaging state based on the measurement result. In other words, the conventional exposure method need only take account of expansion components during exposure.

However, the double exposure method performs an exposure operation by exchanging a certain reticle A for another reticle B after the preceding exposure operation using the reticle A, so a standby state in which exposure using the reticle A is stopped continues during the exchange. In a standby state in which exposure is stopped, the reticle A cools down and therefore contracts. According to this fact, when the pattern of the reticle A is again transferred onto the next and subsequent substrates by exposure, high-accuracy overlay is impossible unless the deformation component of the reticle A attributed to its contraction is controlled. Exposure using the reticle B cannot be done with high overlay accuracy, either, because it heats up in an exposure state and cools down in a standby state repeatedly.

Although the reticle deformation component can be directly measured for each reticle exchange, this requires a certain measurement time and therefore lowers the throughput. The double exposure method already has the demerit of requiring a reticle exchange time, so the above-mentioned measure worsens the throughput.

### SUMMARY OF THE INVENTION

The present invention provides an exposure apparatus which allows high-accuracy exposure without lowering the throughput even when the reticle enters a standby state during an exposure operation.

According to the present invention, there is provided an exposure apparatus which transfers a pattern of a reticle onto a substrate via a projection optical system, the apparatus comprising a controller configured to correct an image of the pattern, formed on the substrate, in accordance with a shape of the reticle in a standby state until an exposure operation starts.

According to the present invention, it is possible to provide an exposure apparatus which allows high-accuracy exposure without lowering the throughput even when the reticle enters a standby state during an exposure operation.

Further features of the present invention will become apparent from the following description of exemplary embodiments with reference to the attached drawings.

### BRIEF DESCRIPTION OF THE DRAWINGS

FIG. 1 is a schematic view showing a single-stage type exposure apparatus;

FIG. 2 is a schematic view for explaining baseline measurement;

FIG. 3 is a graph showing reticle expansion and contraction states in exposure and standby states, respectively;

FIG. 4 is a schematic view showing a two-stage type exposure apparatus;

FIGS. 5A to 5C are tables showing examples of the sequence of the double exposure method in a two-stage type exposure apparatus;

FIGS. 6A and 6B are schematic views showing the second embodiment;

FIG. 7 is a schematic view showing another mode of the second embodiment;

FIG. 8 is a schematic view showing the third embodiment;

FIG. 9 is a schematic view showing another mode of the third embodiment; and

FIG. 10 is a schematic view showing the result of measuring the light amount in calibration.

### DESCRIPTION OF THE EMBODIMENTS

### First Embodiment

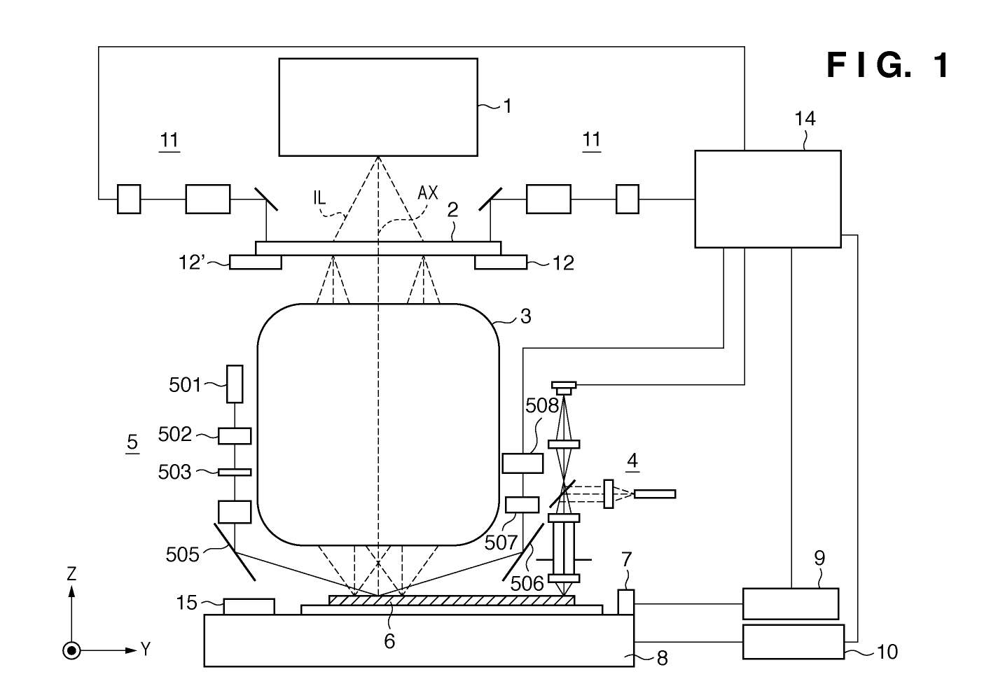

An exposure apparatus will be schematically explained with reference to FIG. 1. The exposure apparatus transfers the pattern of a reticle 2 onto a substrate 6 via a projection optical system 3. Light emitted by an illumination system 1 which performs illumination with exposure light illuminates the reticle 2 arranged with reference to reticle set marks 12 and 12′ formed on a reticle stage (not shown). The reticle 2 is positioned by a reticle alignment scope 11 which can be used to simultaneously observe the reticle set marks 12 and 12′ and reticle set marks (not shown) formed on the reticle 2. The alignment scope 11 uses the exposure light source as an observation light source, can move above the reticle 2, and can be used to observe both the surfaces of the reticle 2 and substrate 6 through the reticle 2 and the projection optical system 3 at a plurality of image heights in the projection optical system 3. In other words, the alignment scope 11 can also detect positions above the reticle 2 and the substrate 6. A scope which can be used to observe the reticle 2 and the substrate 6 through the projection optical system 3, and another scope which can measure the reticle set marks 12 and 12′ may be provided separately.

The light transmitted through the pattern on the reticle 2 forms an image on the substrate 6 by the projection optical system 3 to form an exposure pattern on the substrate 6. An area exposed by one exposure at this time is commonly called a shot. The substrate 6 is held by a substrate stage 8 which can be driven in the X, Y, Z, and rotation directions. Baseline measurement reference marks 15 (to be described later) are formed on the substrate stage 8.

Alignment marks (not shown) are formed on the substrate 6, and their positions are measured by a position detector 4. The position of the substrate stage 8 is always measured by an interferometer 9 which refers to a mirror 7, and shot arrangement information formed on the substrate 6 is calculated based on the measurement result obtained by the interferometer 9 and the alignment mark measurement result obtained by the position detector 4.

Prior to exposing the substrate 6, it must be aligned with the focus position of an image formed by the projection optical system 3. To meet this need, focus detectors 501 to 508 detect the position of the substrate 6 in the focus direction. Light emitted by a light source 501 obliquely projects an image of a slit pattern 503 onto the substrate 6 via an illumination lens 502, the slit pattern 503, and a mirror 505. The slit pattern projected onto the substrate 6 is reflected by the surface of the substrate 6 and reaches a photoelectric conversion device 508 such as a CCD by a detection lens 507 set on the opposite side of the detectors 501 to 508 with respect to the projection optical system 3. The position of the substrate 6 in the focus direction can be measured based on the position of the slit image obtained by the photoelectric conversion device 508.

As described above, before the position detector 4 detects shot arrangement information formed on the substrate 6, it is necessary to obtain the relative positional relationship (baseline) between the position detector 4 and the reticle 2.

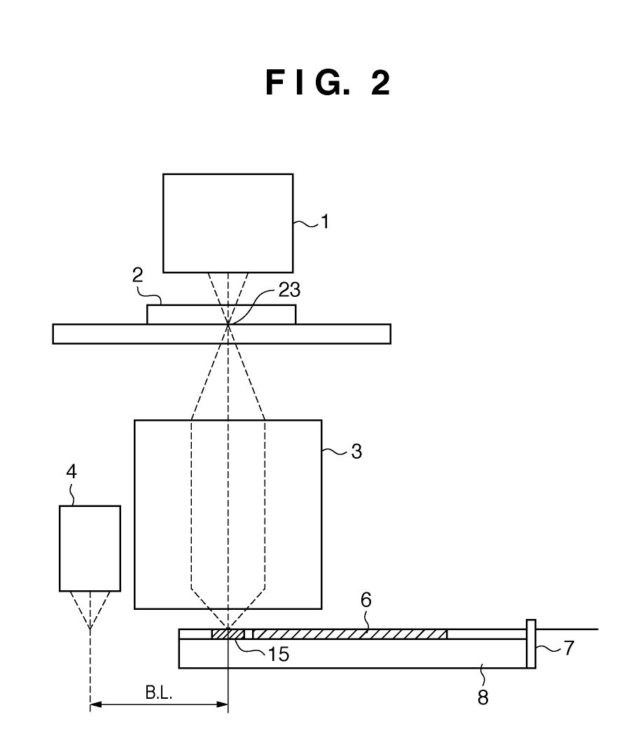

An outline of a method of measuring the baseline will be explained with reference to FIG. 2. FIG. 2 shows position correction marks (to be referred to as “calibration marks” hereinafter) 23 formed on the reticle 2. As the illumination system 1 illuminates the calibration marks 23, the light having passed through the transmissive parts of the calibration marks 23 forms images of their aperture patterns at a best focus position on the side of the substrate 6 by the projection optical system 3. On the other hand, reference marks 15 are formed on the substrate stage 8. The reference marks 15 have aperture patterns with the same sizes as those of the projected images of the calibration marks 23 on the reticle 2 described above. The light transmitted through the aperture patterns reaches a photoelectric conversion device set under the reference marks 15. The photoelectric conversion device can measure the intensity of the light transmitted through the aperture patterns.

In addition to the aperture pattern corresponding to the calibration mark 23, a position measurement mark which can be detected by the position detector 4 is formed on the reference mark 15. The position of the position measurement mark is obtained based on the result of driving the position measurement mark into the field of view of the position detector 4 and detecting its position by the position detector 4, and the interferometric result at that time.

A method of obtaining the position (baseline) of the position detector 4 relative to the projection optical system 3 using the reference marks 15 described above will be explained in detail below. First, a reticle stage 20 is driven so that the exposure light passes through the calibration marks 23 formed on the reticle 2. The illumination system 1 illuminates the calibration marks 23, which have been moved to predetermined positions by driving the reticle stage 20, with the exposure light. The light having passed through the transmissive parts of the calibration marks 23 forms images of their mark patterns at imaging positions in the space above the substrate. The substrate stage 8 is driven so that the positions of the mark pattern images are aligned with those of the aperture patterns having the same shapes. At this time, the value output from the photoelectric conversion device is monitored by moving the aperture patterns in the X direction while the reference marks 15 are positioned on the imaging plane (best focus plane) of the calibration marks 23. FIG. 10 is a schematic graph plotting the relationship between the position of the aperture pattern in the X direction and the value output from the photoelectric conversion device. In FIG. 10, the abscissa indicates the position of the aperture pattern in the X direction, and the ordinate indicates a value I output from the photoelectric conversion device. In this manner, as the relative position between the calibration mark 23 and the aperture pattern changes, the obtained output value also changes. Of light components which exhibit a curve 40 shown in FIG. 10, the one having passed through the calibration mark 23 has a maximum intensity at a position (X0) aligned with that of the aperture portion of the aperture pattern. The position of a projected image of the calibration mark 23, which is formed in the space above the substrate by the projection optical system 3, is obtained by obtaining the aligned position X0.

It is also possible to measure the shape (the magnification and distortion states) of the pattern of the reticle 2 by forming calibration marks 23, as described above, at a plurality of portions on the reticle 2 and measuring the positions of the calibration marks 23 using the reference marks 15.

In the double exposure method, a first pattern formed on a first reticle is transferred onto one given substrate by exposure. After that, the first reticle is exchanged for a second reticle by a reticle transport system (not shown), and the pattern of the second reticle is sequentially transferred onto the given substrate without developing the first pattern. In multiple exposure which uses three or more reticles, exposure is sequentially repeated three or more times without developing the transferred pattern(s). In other words, one substrate is exposed using a plurality of reticles by sequentially exchanging them, and the same operation is repeated for each of a plurality of substrates, if there are more than one substrate.

The reason why exposure is performed in accordance with the above-mentioned procedure is as follows. For example, when a plurality of substrates are present, a method of exposing all substrates using a first reticle, and exposing them again using second and subsequent reticles after the exposure using the first reticle is completed is also plausible in this situation. Since this method can minimize the reticle exchange time because of a decrease in the number of times of reticle exchange, it has the merit of improving the throughput. At the same time, this method requires substrate alignment measurement every time second and subsequent reticles are used, so it has the demerit of degrading the overlay accuracy. In contrast, the former exposure method, that is, a method of exposing one given substrate using a plurality of reticles after alignment measurement of the given substrate is completed, and exposing the next substrate thereafter has the merit of preventing the overlay accuracy from degrading.

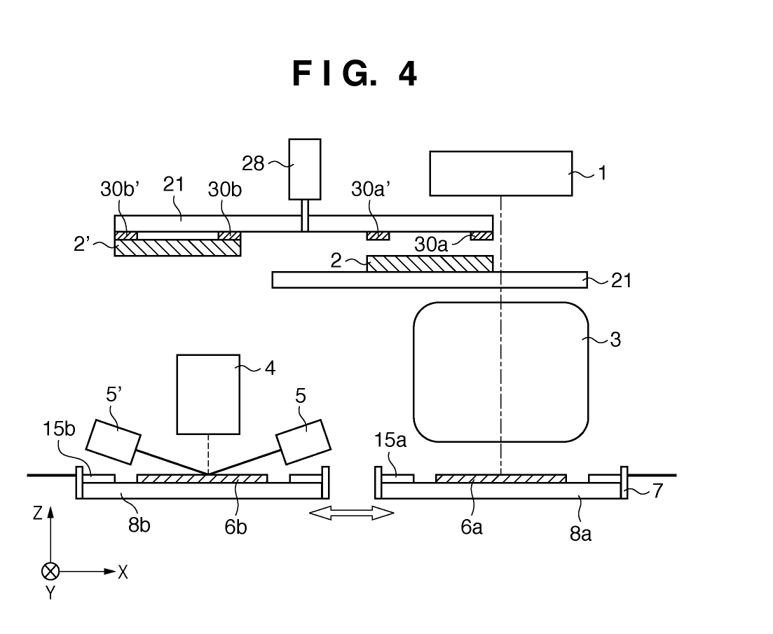

An example of a single-stage type exposure apparatus including only one substrate stage 8 has been described above. A two-stage type exposure apparatus including a plurality of substrate stages, which can improve the throughput than ever, has recently become available. FIG. 4 is a schematic view showing the two-stage type exposure apparatus. The double exposure method in the two-stage type exposure apparatus will be explained below.

The same reference numerals as in FIG. 1 denote elements having the same functions in FIG. 4, and a detailed description thereof will not be given.

A large difference between the single-stage type exposure apparatus and the two-stage type exposure apparatus shown in FIGS. 1 and 4, respectively, is that the latter apparatus includes a measurement area for alignment and focus measurement and an exposure area for exposure. The two-stage type exposure apparatus exposes a plurality of substrates while swapping a plurality of (two in FIG. 4) substrate stages 8a and 8b between these two areas so as to alternately perform measurement and exposure for the substrates on these stages. Such an arrangement has the merit of performing measurement associated with, for example, alignment parallel to an exposure operation, thereby securing a long time for measurement. Hence, the two-stage type exposure apparatus can provide high-accuracy exposure by repeating the above-mentioned measurement a plurality of times, increasing the number of measurement shots, and performing various types of measurements. To put it another way, measurement and exposure can be performed simultaneously, thus improving the throughput.

In the measurement area, the position detector 4 sequentially measures alignment marks (not shown) formed on a substrate 6a or 6b. By this measurement, a shot arrangement formed on the substrate 6a or 6b is calculated (so-called global alignment measurement). Note that prior to the global alignment measurement, a reference mark 15a or 15b formed on the substrate stage 8a or 8b is measured. With this operation, the relative positional relationship between the reference mark 15a or 15b and the substrate 6a or 6b is measured.

When the global alignment measurement is complete, a focus detector 5 or 5′ measures the position information of the substrate 6a or 6b in the level (focus) direction. The focus detector 5 or 5′ is fixed in position with respect to the substrate stage 8a or 8b, and measures the level (in the Z direction) of the entire substrate surface while driving the substrate stage 8a or 8b in the X and Y directions. Note that prior to the measurement of the substrate level in the focus direction, the focus detector 5 or 5′ measures the reference mark 15a or 15b to detect the relative positional relationship between the reference mark 15a or 15b and the substrate 6a or 6b.

When the alignment mark measurement and the focus measurement are complete, the substrate stage 8a or 8b moves to the exposure area while holding the substrate 6a or 6b. At this time, it is important to drive the substrate stage 8a or 8b without changing the relative positional relationship between the substrate 6a or 6b and the reference mark 15a or 15b.

The relative position (in the X, Y, and focus directions) between the reference mark 15 on the substrate stage which has moved to the exposure area and the calibration mark (not shown), described with reference to FIG. 2, formed on the reticle 2 is detected using exposure light. This detection is done by the method previously described with reference to FIG. 2. This makes it possible to obtain the relationship between the reticle 2 and the substrate stage 8a. As the relationship between the reticle 2 and the substrate stage 8a is obtained, an exposure operation is performed based on the shot arrangement information and focus information measured in the measurement area.

The foregoing description is about the operation especially in the space surrounding the substrate stage, whereas the following description is about the arrangement in the space surrounding the reticle.

A reticle transport system 21 for loading a reticle 2 or 2′ onto the reticle stage 20 is provided. Referring to FIG. 4, the reticle transport system 21 constitutes two chucking units 30 or 30′ fixed to a rotation axis 28. These chucking units 30 or 30′ can chuck the reticle 2 or 2′ and load/unload it onto/from the reticle stage 20 by rotation. For example, exposure which alternately uses two reticles is performed after alternately loading/unloading the reticles by rotating the reticle transport system 21.

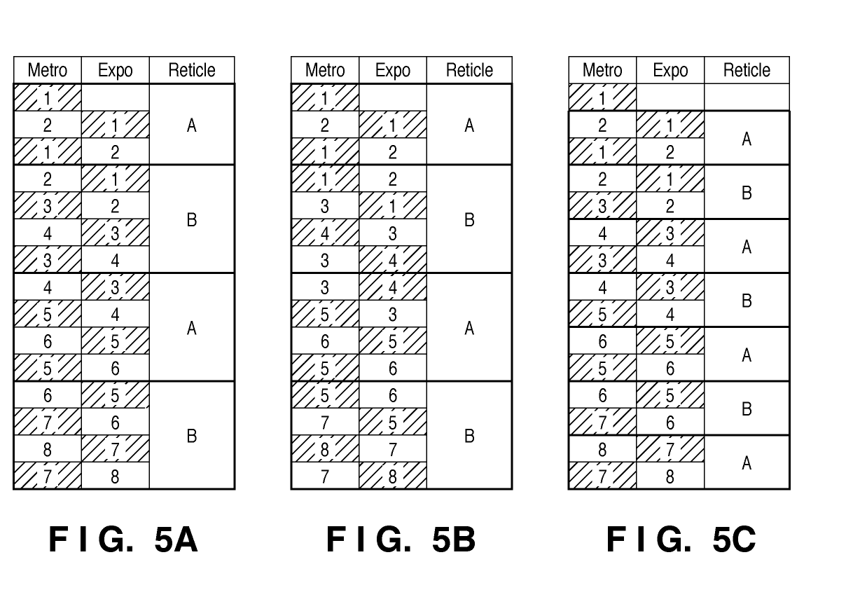

A case in which the double exposure method is applied to a two-stage type exposure apparatus as described above will be described with reference to FIGS. 5A to 5C. FIGS. 5A to 5C are tables for explaining three methods in the exposure sequence when double exposure is performed on a plurality of substrates 6a or 6b using two types of reticles. A “Metro” column indicates the number of a given substrate processed in the measurement area, and an “Expo” column indicates the number of a substrate processed in the exposure area concurrently with the processing of the given substrate. A hatched cell indicates the substrate stage 8a, and a white cell indicates the substrate stage 8b. A “Reticle” column indicates the type of reticle 2 and this means that exposure is performed by alternately using two types of reticles “A” and “B” in FIGS. 5A to 5C.

In the table shown in FIG. 5A, first substrate No. 1 undergoes alignment measurement (first row) and is exposed using the reticle A. Concurrently with this exposure, substrate No. 2 undergoes alignment measurement (second row). Substrate No. 2 is driven to the exposure area and is exposed using the reticle A in the same way. During this exposure, substrate No. 1 returns to the measurement area to stand by for exposure using the next reticle B (third row). When the exposure of substrate No. 2 is complete, the reticles A and B are exchanged and substrates Nos. 1 and 2 are swapped at the same time, and then substrate No. 1 is exposed using the reticle B (fourth row). When the exposure of substrate No. 1 is complete, it is swapped for substrate No. 2, and the pattern of the reticle B is transferred onto substrate No. 2 by exposure. Parallel to this exposure, exposed substrate No. 1 is unloaded outside the apparatus, and next substrate No. 3 is loaded and undergoes alignment measurement (fifth row). Exposure is repeated for subsequent substrates by alternately exchanging the reticles A and B and swapping the substrates, as shown in FIG. 5A. The use of an exposure sequence as above allows a decrease in the number of times of reticle exchange. This makes it possible to improve the throughput when, for example, it takes a long time to exchange the reticles.

The table shown in FIG. 5B is different from that shown in FIG. 5A in that after exposure of substrate No. 2 using the reticle A is completed, the reticle A is exchanged for the reticle B and substrate No. 2 is exposed using the reticle B while it stays in the exposure area (fourth row). Then, substrate No. 1 is transported to the exposure area and is exposed using the reticle B. The exposure sequence in the table shown in FIG. 5B can lessen the frequency of substrate swapping as compared with that in the table shown in FIG. 5A, as described above. This makes it possible to improve the throughput as much as possible when it takes a long time to swap the substrate stages.

In the above-mentioned tables shown in FIGS. 5A and 5B, the order of exposure operations using the reticles A and B differs among individual substrates. For example, substrates Nos. 1 and 2 are exposed using the reticles A and B in this order, whereas substrates Nos. 3 and 4 are exposed using the reticles B and A in this order. The substrate often expands due to heat generated upon exposure. In this case, when the order of exposure operations using reticles A and B which give rise to different exposure amounts is altered, the amount of expansion upon exposure changes. This may degrade the overlay accuracy. To handle this situation, all exposure operations are performed using reticles and substrates in the same orders, and the expansions of the substrates are corrected by a predetermined offset, thus ensuring high overlay accuracy. FIG. 5C is a table showing the exposure sequence in this case. This sequence can use reticles in the same order for all substrates and expose all substrates in the same order. On the other hand, this sequence requires frequent reticle exchange and substrate swapping, so it may lower the throughput owing to the necessity of the time taken for these operations. As described above, the throughput can be improved as much as possible by selecting a sequence in accordance with the required accuracy.

Double exposure is performed using a plurality of reticles by the above-mentioned sequence. Note that attention must be paid to, for example, the behavior of the reticle B unloaded while exposure using the reticle A is in progress. Because a reticle generally has a pattern which is made of a metal such as Cr and formed on quartz, it naturally absorbs exposure light upon exposure and expands due to absorbed heat. During the exposure, the expansion of the reticle progresses until it reaches saturation in which heat dissipation and absorption are balanced. Conversely, when the reticle enters a standby state and exposure is stopped, cooling of the reticle progresses and therefore it contracts. In other words, the reticle repeatedly expands upon exposure and contracts upon standby (stop). Such reticle expansion/contraction generates so-called overlay errors, so it is necessary to perform exposure so as to minimize the generation of overlay errors or correct the generation amount of these errors.

In the double exposure method, a reticle being exposed expands, while that which is standing by for the start of an exposure operation contracts. For example, during exposure using the reticle A, the reticle A expands, while the reticle B which is standing by contracts. In a conventional exposure method other than the double exposure method, substrates are always exposed using one reticle. This allows exposure while reducing overlay errors by monitoring the expansion state of the reticle by calibration measurement and adjusting the optical performance (e.g., the magnification and distortion) of the projection optical system or by controlling the driving operation of the reticle stage. In contrast, in the double exposure method, the reticle inevitably cools down upon reticle exchange after exposure, and this degrades the overlay performance unless the contraction state of the reticle is controlled.

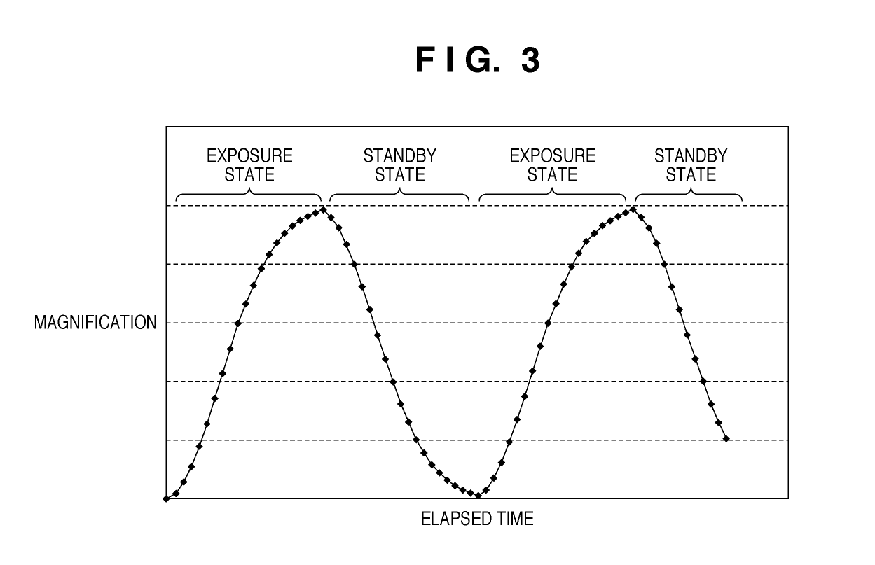

FIG. 3 is a graph schematically showing a change in expansion/contraction (magnification error) of the reticle upon reticle heating/cooling. In FIG. 3, the abscissa indicates the elapsed time, and the ordinate indicates the reticle magnification error. In an exposure state, the magnification component increases due to expansion. In contrast, when the reticle enters a standby state, it cools down (dissipates heat) and therefore contracts. In this manner, the reticle repeatedly expands/contracts. Although the reticle expansion/contraction is represented as a magnification component in FIG. 3, it also occurs as a higher-order error component such as distortion. The same mechanism applies to a higher-order error component, and a detailed description thereof will not be given.

A method of correcting the reticle expansion in an exposure state and the reticle contraction in a standby state will be explained. Reticle expansion in an exposure state and reticle contraction in a standby state, shown in FIG. 3, are estimated and corrected. A controller 14 of the exposure apparatus receives information representing the shape of the reticle 2 at a given time (reference time) after an exposure operation preceding a standby state is completed. The shape information of the reticle 2 at the reference time can be calculated based on information including, for example, the exposure area on the reticle, that is, the irradiation range of the exposure light, its size, the exposure amount, and the exposure time in the preceding exposure operation. Also, the shape of the reticle 2 at a reference time can be detected by position detectors 32 and 33 as will be described in the second embodiment. In this case, the position detectors 32 and 33 constitute a first detector which detects the shape of the reticle 2 at a given time after the preceding exposure operation is completed.

The controller 14 calculates the shape of the reticle 2 in a standby state based on information representing the shape of the reticle 2 at a reference time, and the standby time, that is, the time elapsed from the reference time. The controller 14 predicts the magnification state while exposure again using the reticle 2 is ready, and adjusts, based on the predicted value, the optical performance of the projection optical system 3 to correct the pattern image. The reticle expansion and contraction characteristics may also be measured in advance, and time constants (the times until the reticle expansion and contraction reach saturations) and their occurrence amounts (coefficients) in a steady state may be calculated. As a method of calculating these coefficients, the reticle 2 is irradiated with exposure light while being mounted on the reticle stage 20. The reticle expansion state is measured by the calibration measurement shown in FIG. 2. After that, while the reticle 2 is mounted on the reticle stage 20, the exposure is stopped, so the reticle 2 enters a standby state. The coefficients can be calculated by calibration measurement of the reticle contraction in a standby state, as in the reticle expansion. Instead of the measurement, the coefficients may be calculated based on simulation. In both cases, it is possible to guarantee high-accuracy overlay in the double exposure method by predicting a reticle expansion characteristic in an exposure state and a reticle contraction characteristic in a standby state based on the elapsed time, correcting these characteristics at the time of exposure, and performing the exposure.

### Second Embodiment

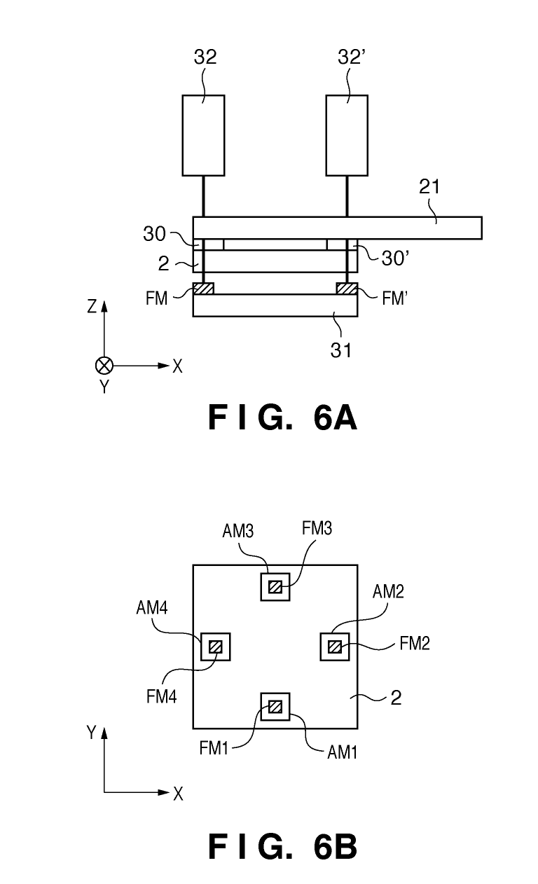

A method of estimating and correcting reticle contraction in a standby state has been described in the first embodiment. However, a method of correcting that contraction with higher accuracy will be explained with reference to FIGS. 6A and 6B in the second embodiment. Note that the same reference numerals as in the first embodiment denote elements having the same functions in the second embodiment, and a detailed description thereof will not be given. FIG. 6A is a side view of the reticle vicinity when viewed sideways, and FIG. 6B is a top view of the reticle vicinity when viewed from above. The feature in FIGS. 6A and 6B is that a position detector 32 or 32′ which can be used to observe and measure alignment marks formed on a reticle 2 is set at the standby position of the reticle 2. The position detector 32 or 32′ is a second detector which detects the contraction state of the reticle 2 in a standby state, and measures the shape of a given reticle 2 at the standby position after exposure of the given reticle 2 is completed. Alignment marks AM are formed on the lower surface of the reticle 2. A reference plate 31 serving as a reference is juxtaposed to the alignment marks AM in the Z direction. Reference patterns FM serving as references for the alignment marks AM formed on the reticle 2 are formed on the reference plate 31. FIG. 6B is a schematic view showing the relationship between the reference patterns FM and the alignment marks AM, in which each reference pattern FM falls within the corresponding alignment mark AM. The position detector 32 or 32′ is set at a position corresponding to each set of the alignment mark AM and the reference pattern FM, and can be used to simultaneously observe the alignment mark AM and the reference pattern FM. The shape of the reticle 2 in a standby state can be measured by detecting the positions of the alignment marks AM with respect to the reference patterns FM. In other words, in FIG. 6B, the contraction state of the reticle 2 in the X and Y directions can be measured by detecting the relative positions between four alignment marks AM1 to AM4 and four reference patterns FM1 and FM4. Note that the temperature of the reference plate 31 is controlled so as to prevent the expansion/contraction of the reference plate 31, differently from the reticle 2. Alternatively, the expansion/contraction states of the reference plate 31 are precisely controlled by measuring its temperature. Since the shape of the reticle 2 in a standby state can be directly measured in this way, it is possible to control overlay with higher accuracy and measure a certain reticle parallel to exposure of another reticle. Hence, this method has the merit of preventing the throughput from lowering. By the above-mentioned measurement, the contraction state of the reticle 2 is monitored, the contraction is corrected at the start of exposure, and exposure is performed.

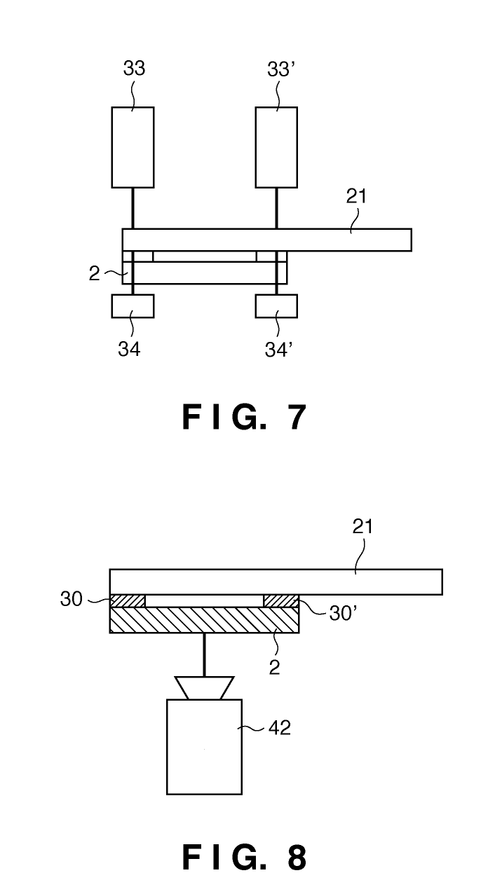

A method which uses a reference plate 31 has been described above. In contrast, FIG. 7 shows a method which uses no reference plate 31. Referring to FIG. 7, a position detector 33 or 33′ fixed in position as in the position detector 32 described previously is arranged. Because the position detector 32 or 32′ shown in FIG. 6A uses a reference plate, it is not so important to secure the stability of the position detector 32 or 32′. This is because it is only necessary to detect the relative positions between the alignment marks AM and the reference patterns FM. On the other hand, in FIG. 7, the shape of the reticle 2 is detected with reference to the position of the position detector 33 or 33′ instead of using the reference plate 31. An illumination system 34 or 34′ which emits illumination light is set beneath the reticle 2. The light from the illumination system 34 or 34′ transmissively illuminates alignment marks formed on the reticle 2. The positions of the alignment marks can be detected by detecting, by the position detector 33 or 33′, the light transmitted through the alignment marks. The positions of the alignment marks with respect to the position detector 33 or 33′ are thus detected. A magnification component and the like can be calculated based on the detection results obtained by the position detectors 33 and 33′.

Since the magnification component (e.g., distortion) calculated in the above-described way can be measured in a standby state, it is possible to achieve high-accuracy overlay exposure by adjusting the optical performance of the projection optical system at the time of exposure.

### Third Embodiment

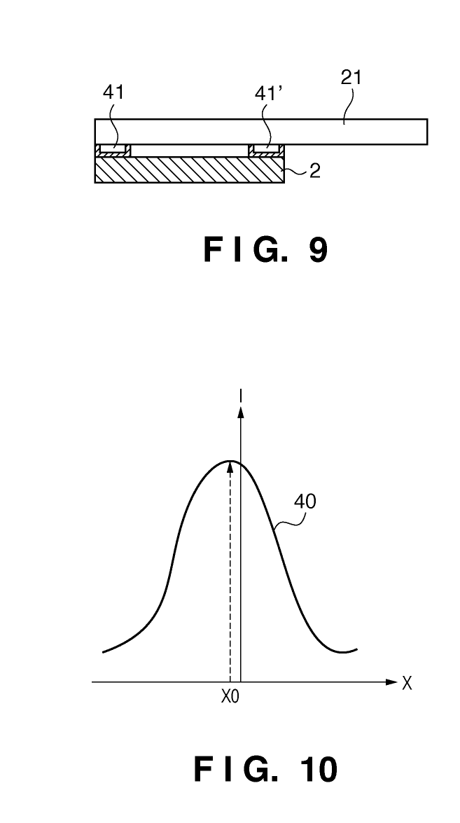

A method of detecting alignment marks formed on a reticle 2 to detect the shape of the reticle 2 during standby, and performing exposure based on the detected information has been described in the second embodiment. Another embodiment will be explained with reference to FIGS. 8 and 9 herein.

In this embodiment, an infrared camera 42 is provided so as to measure the temperature distribution of a reticle 2. The infrared camera 42 captures infrared rays coming from the entire surface or a specific region of the reticle 2, and measures the temperature distribution of the reticle 2 from the captured infrared rays. The shape of the reticle 2 in a standby state is predicted based on the measured temperature distribution. The infrared camera 42 is a fourth detector which detects the temperature distribution of the reticle 2 in a standby state.

The shape based on the temperature distribution may be measured in advance, or the relationship between the temperature distribution and the shape may be obtained by simulation. In both cases, a controller 14 monitors the shape of the reticle 2 in a standby state based on the detected temperature distribution of the reticle 2, and corrects the optical performance of a projection optical system 3 at the time of exposure. This makes it possible to guarantee a given overlay accuracy in the double exposure method. It is also possible to achieve high overlay accuracy without lowering the throughput because exposure is performed parallel to that detection.

Another mode of the method of monitoring the temperature distribution will be described with reference to FIG. 9. Referring to FIG. 9, a chucking unit 41 or 41′ which chucks the reticle 2 includes a temperature sensor. Since the chucking unit 41 or 41′ is in contact with the reticle 2, it can measure the temperature of the reticle 2. The temperature sensor according to this mode is a third detector which detects the temperature of a specific portion of the reticle 2 in a standby state.

The controller 14 predicts the shape of the reticle 2 from the measured temperature, and corrects the pattern image based on the predicted value, as in the above-mentioned method. In this mode as well, the relationship between the temperature and shape of the reticle 2 may be obtained by measuring them in advance or may be obtained by simulation. In both cases, it is possible to achieve high-accuracy overlay without lowering the throughput by exposure while monitoring the shape of the reticle 2 in a standby state and correcting the optical performance of the projection optical system 3 at the time of exposure.

A method of predicting and detecting the shape of the reticle 2 in a standby state and correcting the pattern image in the double exposure method has been explained in the first to third embodiments by taking a two-stage type exposure apparatus as an example. However, as can be easily understood, this method is similarly applicable to a conventional single-stage type exposure apparatus and multiple exposure which uses three or more reticles.

An exemplary method of manufacturing devices such as a semiconductor integrated circuit device and a liquid crystal display device using the above-mentioned exposure apparatus will be explained next.

The devices are manufactured by an exposure step of exposing a substrate using the above-mentioned exposure apparatus, a development step of developing the substrate exposed in the exposure step, and other known steps of processing the substrate developed in the development step. The other known steps include, for example, etching, resist removal, dicing, bonding, and packaging steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-156998, filed Jun. 16, 2008, which is hereby incorporated by reference herein in its entirety.

What is claimed is:

1. An exposure apparatus which transfers a pattern of a reticle onto a substrate via a projection optical system, the apparatus comprising:
a controller configured to correct an image of the pattern, formed on the substrate, in accordance with a shape of the reticle in a standby state until an exposure operation starts.

2. The apparatus according to claim 1, wherein said controller calculates a shape of the reticle in a standby state based on information representing a shape of the reticle at a given time after an exposure operation preceding the standby state is completed, and a standby time of the reticle from the given time until the next exposure operation starts, and corrects an image of the pattern in accordance with the calculated shape of the reticle.

3. The apparatus according to claim 2, wherein said controller calculates the information representing the shape of the reticle at the given time based on information including an exposure area and exposure amount of the reticle.

4. The apparatus according to claim 2, further comprising:
a first detector configured to detect the shape of the reticle, and
said first detector detects the information representing the shape of the reticle at the given time.

5. The apparatus according to claim 1, further comprising:
a second detector configured to detect a shape of the reticle in a standby state, and
said controller corrects an image of the pattern in accordance with the shape of the reticle in the standby state, which is detected by said second detector.

6. The apparatus according to claim 1, further comprising:
a third detector configured to detect a temperature of the reticle in a standby state, and
said controller calculates a shape of the reticle in the standby state based on the temperature detected by said third detector, and corrects an image of the pattern in accordance with the calculated shape.

7. The apparatus according to claim 1, further comprising:
a fourth detector configured to detect a temperature distribution of the reticle in a standby state, and
said controller calculates a shape of the reticle in the standby state based on the temperature distribution detected by said fourth detector, and corrects an image of the pattern in accordance with the calculated shape.

8. The apparatus according to claim 1, wherein the exposure apparatus sequentially transfers patterns of a plurality of reticles onto a substrate without developing the transferred patterns.

9. The apparatus according to claim 1, wherein said controller adjusts the projection optical system to correct an image of the pattern.

10. A method of manufacturing a device, the method comprising:
exposing a substrate using an exposure apparatus which transfers a pattern of a reticle onto a substrate via a projection optical system;
developing the exposed substrate; and
processing the developed substrate to manufacture the device,
wherein the exposure apparatus includes a controller configured to correct an image of the pattern, formed on the substrate, in accordance with a shape of the reticle in a standby state until an exposure operation starts.
